(19) United States
(12) Patent Application Publication
(10) Pub. No.: US 2017/0123491 A1
(43) Pub. Date: May 4, 2017

(54) COMPUTER-IMPLEMENTED GAZE INTERACTION METHOD AND APPARATUS

(71) Applicant: ITU Business Development A/S, København S (DK)

(72) Inventors: Dan Witzner Hansen, Ølstykke (DK); Diako Mardanbegi, Copenhagen (DK)

(21) Appl. No.: 15/126,596

(22) PCT Filed: Mar. 16, 2015
(86) PCT No.: PCT/EP2015/055435

§ 371 Date: Sep. 16, 2016

(30) Foreign Application Priority Data
Mar. 17, 2014 (DK) PA201470128

(51) Int. Cl. G06F 3/01; G06F 3/0482

(52) U.S. Cl. CPC G06F 3/013; G06F 3/0482; G06F 3/012

(57) ABSTRACT

A computer-implemented method of communicating via interaction with a user-interface based on a person's gaze and gestures, comprising: computing an estimate of the person's gaze comprising computing a point-of-regard on a display through which the person observes a scene in front of him; by means of a scene camera, capturing a first image of a scene in front of the person's head (and at least partially visible on the display) and computing the location of an object coinciding with the person's gaze; by means of the scene camera, capturing at least one further image of the scene in front of the person's head, and monitoring whether the gaze dwells on the recognised object; and while gaze dwells on the recognised object: firstly, displaying a user interface element, with a spatial expanse, on the display face in a region adjacent to the point-of-regard; and secondly, during movement of the display, awaiting and detecting the event that the point-of-regard coincides with the spatial expanse of the displayed user interface element. The event may be processed by communicating a message.

Eye-tracking is an evolving technology that is about to become a technology integrated in various types of consumer products such as mobile devices like smart phones or tablets or mobile devices such as Wearable Computing Devices, WCDs comprising Head-Mounted Displays, HMDs. Such devices may be denoted mobile devices in more general terms.

### RELATED PRIOR ART

US2013/0135204 discloses a method for unlocking a screen of a head-mounted display using eye tracking information. The HMD or WCD may be in a locked mode of operation after a period of inactivity by a user. The user may attempt to unlock the screen. The computing system may generate a display of a moving object on the display screen of the computing system. By means of gaze estimation the HMD or WCD may determine that a path associated with the eye movement of the user substantially matches a path associated with the moving object on the display and switch to be in an unlocked mode of operation including unlocking the screen.

US2013/0106674 discloses a head-mounted display configured to be worn by a person and track the gaze axis of the person's eye, wherein the HMD may change a tracking rate of a displayed virtual image based on where the user is looking. Gazing at the centre of the HMD field-of-view may allow for fine movements of the displayed virtual image, whereas gazing near an edge of the HMD field of view may give coarser movements. Thereby the person can e.g. scroll at a faster speed when gazing near an edge of the HMD field-of-view. The HMD may be configured to estimate the person's gaze by observing movement of the person's pupil.

US2013/0246967 discloses a method for a wearable computing device (WCD) to provide head-tracked user interaction with graphical user interface thereof. The method includes receiving movement data representing a movement of the WCD from a first to a second position. Responsive to the movement data the method controls the WCD such that the menu items become viewable in the view region. Further, while the menu items are viewable in the view region, the method uses movement data to select a menu item and maintain a selected menu item fully viewable in the view region. The movement data may represent a person's head or eye movements. The movement data may be recorded by sensors such as accelerometers, gyroscopes, compasses or other input devices to detect triggering movements such as upward movement or tilt of the WCD. Thereby, a method for selecting menu items is disclosed.

These prior art documents show different ways in which a person can interact with a user interface of a wearable computing device. However, the documents fail to disclose an intuitive way for a person to initiate communication with a remote object that the person comes across in the real or physical world and sees through or on his or her wearable computing device.

In general throughout this application the term ‘person’ is used to designate a (human) being that uses or wears a mobile device or unit configured with a computer that is configured and/or programmed to perform the computer-implemented method according to one or more of the embodiments described below. As an alternative to the term ‘person’, the term ‘user’ is used.

### SUMMARY

There is provided a computer-implemented method of responding to a person's gaze, comprising: computing an estimate of the person's gaze comprising computing a point-of-regard on a screen through which the person observes a scene; identifying an object the person is looking at, if any, using the estimate of the person's gaze and information about an object's identity and location relative to the gaze; detecting an event indicating that the person wants to interact with the object; verifying, during movement of the screen, that gaze is fixed on the object; and then detecting the event that the point-of-regard coincides with the spatial expanse of a predefined displayed user interface element; and processing the event comprising performing an action.

Thus, during interaction with the user interface, the person looks at an object via a so-called see-through or non-see-through display e.g. of a wearable computing device or head-mounted display, and when the person wants to interact with the object he/she observes that a user interface element is displayed adjacent to the object or at least adjacent to the estimated point-of-regard. The method may detect that the person wants to interact with the object e.g. by detecting the event that the person's gaze has dwelled on the object or the person has given a spoken or gesture command, pressed a button or the like.

In some embodiments information about an object's identity is generated or acquired by recording images of a scene in front of the the person and performing image processing to recognize predefined objects.

In some embodiments the generation or acquisition of an object's identity comprises determining the position of the object by determining the location of the person, e.g. by a GPS receiver or other position determining method, and the relative position between the object and the person; and querying a database comprising predefined objects stored with position information to acquire information about the object at or in proximity of the determined position. In this way graphical information and positional information is used in combination to acquire the identity of an object form a database. The relative position between the object and the person is determined from the estimated gaze. The relative position may be determined as a solid angle, a direction and/or by estimating a distance to the object.

In some embodiments information about an object's identity is generated or acquired by recording images of a scene in front of the the person and performing image processing to recognize a predefined object at or in proximity of a location relative to the gaze; wherein the location is a location that coincides with the gaze.

The user interface element may be displayed already or be displayed as of the moment when it is detected that the person wants to interact with the object. The visual representation of the user interface element may be given by the display or be printed physically or otherwise occur on the surface of the display. Then, the person moves the display to bring the user interface element on the display to coincide with the object on which his/her gaze dwells. This movement will trigger an event which can be processed e.g. to issue an action to automatically take and store a picture of the object by means of the scene camera and/or to communicate a message to control the object and/or to send a request for receiving information from the object. The message may be communicated via a wired and/or wireless data network as it is known in the art. Consequently, a very intuitive gesture interaction method is provided.

The object is an object in the real world. It may be a real 3D physical object including naturally existing objects, paintings and printed matter, it may be an object displayed on a remotely located display or it may be a virtual object presented in or on a 2D or 3D medium.

A scene camera may record an image signal representing a scene in front of the person's head. The scene camera may point in a forward direction such that its field-of-view at least partially coincides or overlaps with the person's field of view e.g. such that the scene camera and the view provided to the person via the display have substantially the same field of view. When the scene camera is mounted on or integrated with a WCD, it can be assured that the scene camera's field-of-view fully or partially covers or at least follows the person's field-of-view when (s)he wears the WCD.

Images from the scene camera may be processed to identify the object the person is looking at. The identity may refer to a class of objects or a particular object.

The display may be a see-through or non-see-through display and it may have a flat or plane or curved face or the display may have a combination of flat or plane or curved face sections. In case the display is a non-see-through display, and the system has a scene camera, the scene camera may be coupled to the display to allow the person to view or observe the scene via the scene camera and the display. From the person's point of view, i.e. the way (s)he interacts with the user interface, (s)he looks at an object in the real world e.g. a data network operated lamp and the person keeps looking at the object. While (s)he is looking at the object, a user interface element is displayed to him/her in a region of the display such that it is not in the way of the person's gaze on the object. Still, while looking at the object, the person turns the display e.g. by moving his/her's head a bit such that the user interface element that follows the display (and are fixed relative to the display coordinates system) moves to coincide with the user interface element. Thereby the person's gaze coincides with both the spatial expanse of the user interface element and the object. This may raise an event that triggers communication via a data network of a predefined message to the data network operated lamp. The message is composed to activate a function of the lamp as enabled via the data network and as indicated by the user interface. For instance the lamp may have a function to toggle it from an on to an off state and vice versa. The user interface element may have a particular shape, an icon and/or text label to indicate such a toggle function or to indicate any other relevant function.

The computer-implemented method can be performed by a device, such as a Wearable Computing Device (WCD), e.g. shaped as spectacles or a spectacle frame configured with a scene camera arranged to view a scene in front of the person wearing the device, an eye-tracker e.g. using an eye camera arranged to view one or both of the person's eyes, a display arranged such that the user can view it when wearing the device, a computer unit and a computer interface for communicating the predefined message. Such a device is described in US 2013/0246967 in connection with FIGS. 1 through 4 thereof. Alternative means for implementing the method will be described further below.

The person's gaze can be estimated by an eye-tracker with one or more sensors to obtain data that represents movements of the eye, e.g. by means of a camera sensitive to visible and/or infrared light reflected from an eye. The eye tracker may comprise a computing device programmed to process image signals from the sensor and to compute a representation of the user's gaze. The representation of the user's gaze may comprise a direction e.g. given in vector form or as point, conventionally denoted a point-of-regard, in a predefined virtual plane. The virtual plane may coincide with the predefined display plane that in turns coincides with a face of the display.

Displaying a user interface element can be performed by different means e.g. by configuring the user interface as an opaque display with light emitting diodes (a so-called non-see-through HMD), or as a semi-transparent e.g. liquid crystal display, as a semi-transparent screen on which a projector projects light beams in a forward direction (a so-called see-through HMD), or as a projector that in a backwards direction projects light beams onto the user's eye ball.

The user-interface element is a graphical element and may be selected from a group comprising: buttons e.g. so-called radio-buttons, page tabs, sliders, virtual keyboards, or other types of graphical user-interface elements. The user-interface element may be displayed as a semi-transparent element on a see-through display such that the person can see both the object and the graphical element at the same time.

The computer-implemented method detects the event that the point-of-regard coincides with the spatial expanse of the user-interface element while the gaze dwells on the object.

The computer-implemented method may continuously verify whether the gaze is fixed on the object. This can be done by computing the distance between the gaze and a predefined point representing a location of the object. The location of the object may be defined in various ways, e.g. by a coordinate point or multiple coordinate points in the predefined display plane; this may involve computing a coordinate transformation representing a geometrical transformation from a scene camera's position and orientation to the predefined display plane. The at least one point falling within a definition of the location of the object may be a point falling within a geometrical figure representing the location and expanse of the object e.g. a figure enclosing a projection of the object e.g. as a so-called bounding box.

Determining whether the gaze dwells on the object located in the first and the second images may be performed by monitoring whether the point-of-regard coincides with the location of the object in both the first image and a further image. A first temporal definition of dwell may be applied to decide whether the gaze dwells on an object before the user interface is displayed. A second temporal definition of dwell may be applied to decide whether the gaze dwells on the object after the user interface is displayed e.g. while the person turns his/her head, which may comprise an additional time interval to ensure that the person deliberately wants to activate the user interface element.

Monitoring whether the person's gaze dwells on the object can be determined in different ways e.g. by recording a sequence of images with the scene camera and on an on-going basis determining whether location of the object coincides with an estimate of the gaze. A predetermined time interval running from the first time it was detected that the location of the object coincided with the gaze may serve as a criterion for deciding whether a more recent estimate of the gaze coincides with the location of the object.

The step of processing the event by performing an action may be embodied in various ways without departing from the claimed invention. Performing an action may comprise communicating a predefined message. The communication may be take place via a predefined protocol e.g. a home automation protocol that allows remote control of home devices and appliances via power line cords and/or radio links. The predefined message may be communicated in one or more data packets.

A message may also be denoted a control signal, a command, a function call or a procedure call, a request or the like. The message is intended to respond to and/or initiate communication with a remote system that is configured to be a part of or interface with the object in a predefined way.

In embodiments with a scene camera, the scene camera may record a sequence of still images or images from a sequence of images such as images in a video sequence. Some or the images are from a situation where the person's gaze is directed to the object and further image(s) is/are from a later point in time when the person's gaze is still directed to the object, but where the person has turned his/her(s) head a bit and where the gaze coincides with the user interface element.

The step of identifying the object may be performed in different ways. In some embodiments the object is identified by performing image processing to compute features of an object coinciding with the gaze and then retrieving, from a database, an object identifier matching the computed features. The database may be stored locally or remotely. In other embodiments, object identification is based on a 3D model, wherein objects' positions are represented in a 3D model space. The gaze is transformed to a 3D gaze point position, and the 3D model is examined to reveal the identity of one or more objects, if any, coinciding or being in proximity of the 3D gaze point position. The 3D model space may be stored in a local or remote database. The transformation of the gaze, typically represented as a gaze vector relative to a scene camera or WCD or HMD, to a 3D gaze point position may be computed by using signals from position sensors and/or orientation sensors such as accelerometers and/or gyroscopes e.g. 3-axis accelerometers and 3-axis gyroscopes, positioning systems such the GPS system etc. Such techniques are known in the art.

Thereby, it is possible to interact with a particular object selected by the person by targeting the object by his/her gaze.

Initiating object identification may comprise communicating with an object recognition system with a database comprising a representation of predefined objects.

Computing object location and/or object recognition should be sufficiently fast to allow an intuitive user experience, where object location and/or object recognition is performed within less than a second, or less than a few seconds e.g. less than 2.5 seconds, 3 seconds or 5 seconds.

Object identification is a computer-implemented technique to compare an image or a video sequence of images or any representation thereof with a set of predefined objects with the purpose of identifying a matching or best matching predefined object, if any, that best matches an object in the image or images. Object recognition may comprise spatially, temporally or otherwise geometrically isolating an object from other objects to possibly identify multiple objects in an image or image sequence. Object recognition may be performed by a WCD or a HMD or it may be performed by a remotely located computer e.g. accessible via a wireless network. In the latter event, the second image signal or a compressed and/or coded version of it is transmitted to the remotely located computer, which then transmits data comprising an object identifier as a response. The object identifier may comprise a code identifying a class of like objects or a unique code identifying a particular object or a metadata description of the object. Object recognition may be performed in a shared way such that the WCD or HMD performs one portion of an object recognition task and the remote computer performs another portion. For instance the WCD or HMD may isolate objects as described above, determine their position, and transmit information about respective isolated objects to the remote computer for more detailed recognition. Determining an object's position may comprise determining a geometrical shape or set of coordinates enclosing the object in the image signal; such a geometrical shape may follow the shape of the object in the image signal or enclose it as a so-called bounding box. The spatial expanse of the geometrical shape serves as a criterion for determining whether the point-of-regard coincides with or is locked on the object.

In some embodiments the computer-implemented method comprises: displaying the user interface element on the display in a region adjacent to the point of regard; and delaying display of the predefined user interface element until a predefined event is detected.

Thereby it is possible to prevent unintentional popping-up of display elements. Further, it is possible to prevent unintentional communication of a message by a user briefly and coincidentally looking at an object.

The event may be any detectable event indicating that the person wants to interact with the object, e.g. that the person's gaze has dwelled on the object for a predefined period of time, that the person has given a spoken command and/or a gesture command, or that a button is pressed. Other solutions are possible as well.

Also, a delay in combination with monitoring whether the gaze dwells on (is locked on) the object serves as a confirmation step whereby the person deliberately confirms an action.

The delay runs from about the point in time when the event is detected that the point-of-regard coincides with the spatial expanse of the user-interface element while the gaze dwells on the object located in the first and the second images.

The predetermined minimum period of time is e.g. about 600 ms, 800 ms, 1 sec, 1.2 seconds, 2 seconds or another period of time.

Display of the user interface element may be conditioned on the detection that the images from the scene camera have been substantially similar i.e. that the scene camera has been kept in a substantially still position. Thereby, the user interface elements can be arranged in a region truly adjacent to the point of regard and thus requires a deliberate subsequent gesture, moving the scene camera, to activate a user interface element.

In some embodiments the computer-implemented method comprises: entering an interaction state as of the moment when an object the person is looking at is identified; while in the interaction state detecting whether the person's gaze is away from the object; and in the positive event thereof, exiting the interaction state to prevent performing the action.

Thereby, if the user interface element has already been shown, the user interface element is wiped away from the user interface and an eye movement that would or could issue a control signal is abandoned. If the user interface element has not been shown, it will not be shown. This abandonment may be caused by the person intentionally looking away from the object to avoid issuing a control signal. Also, this solution makes it possible to avoid issuing a control signal when the person's gaze is more or less randomly drifting from one object to another.

The method may work when the user interface element is represented visually by a physical item attached to the display or its surface.

In some embodiments, short periods of looking away are disregarded or filtered out. Examples of short periods may be less than 1 seconds, 0.5 seconds or 0.2 seconds, or may be defined by a number of samples at a certain sample rate. This may overcome problems with noise in the gaze estimation, where the gaze momentarily differs from a more stable gaze.

In some embodiments the computer-implemented method comprises: displaying multiple user interface elements, with respective spatial expanses, on the display on a location adjacent to the point-of-regard; wherein the user interface elements are linked with a respective message; determining which, if any, among the multiple user interface elements the point-of-regard coincides with; and selecting an action linked with the determined user interface element.

Thereby the person may use his head gesture or display movements to activate a selected one or more among multiple available actions. This greatly enhances possible use case scenarios.

In the field of programming it is well-known to link user interfaces to a respective message e.g. via techniques of raising events and defining how to respond to an event.

In some embodiments the computer-implemented method comprises: arranging the location and/or size of one or multiple user interface element(s) on the user interface plane in dependence of the distance between the location of the point-of-regard and bounds of the user interface plane.

Thereby the display real estate can be exploited more efficiently. In a situation where the point-of-regard is located much closer to a left hand side bound of the user interface plane, than to a right hand side bound, the one or multiple user interface element(s), can efficiently be arranged with at least a majority of them arranged to the right hand side of the point-of-regard. Similarly, this principle for horizontal arrangement can be equally well applied in a vertical direction, however, subject to the size and form factor of the user interface plane.

In some embodiments the computer-implemented method comprises: estimating a main direction or path of a moving object; and arranging the location of one or multiple user interface element(s) on the display within at least one section thereof in order to prevent unintentional collision with the object moving in the main direction or along the path.

Thereby a main direction, say horizontal, among multiple directions, say vertical and horizontal, is indicated. A section can then be an upper portion or lower portion of the user interface plane. Thus, when an object is estimated to move in a horizontal direction, the at least one user interface element is then located above or below a horizontal line. Similarly, if the object moves up, the user interface element(s) may be positioned in right and/or left hand side sections of the display.

The detection of the main direction may be detected by the scene camera and an object tracker, tracking the object in the scene image or by analysing the gaze and/or head movements.

When as mentioned above, the location and/or size of one or multiple user interface element(s) on the user interface plane is/are arranged in dependence of the distance between the location of the point-of-regard and bounds of the user interface plane, it is possible to reduce the risk of the point-of-regard coinciding with the user interface element simply because the person is following the objects movement with his gaze. Consequently, despite the object moves, it requires a deliberate movement of the person's head to issue a control signal.

In some embodiments the multiple user interface elements are arranged in multiple sections that are each delimited from the user interface plane in the indicated one main direction.

In some embodiments the computer-implemented method comprises: transmitting the message to a remote station configured to communicate with the identified object and/or transmitting the message directly to a communications unit installed with the identified object.

There is also provided a device comprising a display, an eye-tracker a processor and a memory storing program code means adapted to cause the computing device to perform the steps of the method, when said program codes means are executed on the computing device.

There is also provided a computer program product comprising program code means adapted to cause a data processing system to perform the steps of the method set forth above, when said program code means are executed on the data processing system.

The computer program product may comprise a computer-readable medium having stored thereon the program code means. The computer-readable medium may be a semiconductor integrated circuit such as a memory of the RAM or ROM type, an optical medium such as a CD or DVD or any other type of computer-readable medium.

There is also provided a computer data signal embodied in a carrier wave and representing sequences of instructions which, when executed by a processor, cause the processor to perform the steps of the method set forth above.

There is also provided a mobile device, such as a head-worn computing device, configured with a screen and to respond to a person's gaze, comprising: an eye-tracker configured to compute an estimate of the person's gaze comprising computing a point-of-regard on a screen through which the person observes a scene; a processor configured to identify an object the person is looking at, if any, using the estimate of the person's gaze and information about an object's identity and location relative to the gaze; and a processor configured to: detect the event that the person wants to interact with the object; verify, during movement of the screen, that gaze is and remains fixed on the object; and then detect the event that the point-of-regard coincides with the spatial expanse of a predefined user interface element on the screen, and process the event comprising performing an action.

In some embodiments the mobile device is configured to display the user interface element on the screen in a region adjacent to the point of regard; and delay displaying of the predefined user interface element until a predefined event is detected.

In some embodiments the mobile device is configured to: enter an interaction state as of the moment when an object the person is looking at is identified; and while in the interaction state, detecting whether the person's gaze is away from the object; and in the positive event thereof, exit the interaction state to prevent performing the action.

In some embodiments the mobile device is configured to: display multiple user interface elements, with respective spatial expanses, on the screen on a location adjacent to the point-of-regard; wherein the user interface elements are linked with a respective action; determine which, if any, among the multiple user interface elements the point-of-regard coincides with; and select an action linked with the determined user interface element.

In some embodiments the mobile device is configured to: arrange the location and/or size of one or multiple user interface element(s) on the screen in dependence of the distance between the location of the point-of-regard and bounds of the user interface plane.

In some embodiments the mobile device is configured to: estimate a main direction or path of a moving object; and arrange the location of one or multiple user interface element(s) on the display within at least one section thereof in order to prevent unintentional collision with the object moving in the main direction or along the path.

In some embodiments the mobile device is configured to: transmit the message to a remote station configured to communicate with the identified object and/or transmitting the message directly to a communications unit installed with the identified object.

### BRIEF DESCRIPTION OF THE FIGURES

A more detailed description follows below with reference to the drawing, in which:

FIG. 1 shows a side view of a wearable computing device worn by a person;

FIG. 2 shows, in a first situation, frames representing information received or displayed by the computer-implemented method;

FIG. 3 shows, in a second situation, frames representing information received or displayed by the computer-implemented method;

FIG. 4 shows a block diagram for a computer system configured to perform the method;

FIG. 5 shows a flowchart for the computer-implemented method;

FIG. 6 shows a tablet configuration of a computer system configured to perform the method; and

FIG. 7 shows user interface elements arranged to prevent unintentional collision with a moving object.

### DETAILED DESCRIPTION

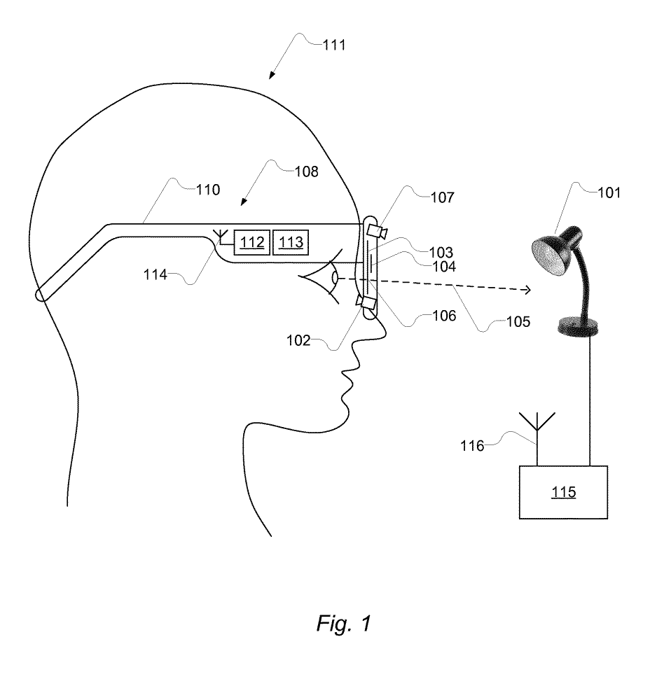

FIG. 1 shows a side view of a wearable computing device worn by a person. The wearable computing device comprises a display 103 of the see-through type, an eye-tracker 102, a scene camera 107, also denoted a front-view camera, and a side bar or temple 110 for carrying the device.

The person's gaze 105 is shown by a dotted line extending from one of the person's eyes to an object of interest 101 shown as an electric lamp. The lamp illustrates, in a simple form, a scene in front of the person. In general a scene is what the person and/or the scene camera views in front of the person.

The person's gaze may be estimated by the eye-tracker 102 and represented in a vector form e.g. denoted a gaze vector. The gaze vector intersects with the display 103 in a point-of-regard 106. Since the display 103 is a see-through display, the person sees the lamp directly through the display.

The scene camera 107 captures an image of the scene and thereby the lamp in front of the person's head. The scene camera outputs the image to a processor 113 that processes the image and identifies the gazed object. The system computes the location of the gaze point inside the scene image. The gaze point in the scene image can be obtained either directly by the gaze tracker or indirectly by having the gaze point in the HMD and the relationship (mapping function) between the HMD and the scene image. Therefore gaze estimation is performed in the HMD and the corresponding point is found in the scene image. Estimating the gaze point inside the HMD or the scene image may require a calibration procedure.

When, and if, a gazed object is recognised, the processor 113 then monitors whether the gaze dwells on the recognised object also when one image or multiple further images is/are captured by the scene camera 107, i.e. whether the gaze dwells on the recognised object for a predefined first period of time. In the affirmative event thereof, the processor 113 displays a user interface element 104, with a spatial expanse, on the display 103 in a region adjacent to the point-of-regard 106. The spatial expanse is illustrated by the expanse extent of a line, but in embodiments the user interface element 104 is an expanse defined in a 2D or 3D space.

Then, the processor 113, during movement of the person's head and thereby during movement of the display 103 through which the person is looking at the lamp 101, awaits and detects the event that the point-of-regard coincides with the spatial expanse of the displayed user interface element 104. In this side view, the user interface element 104 is shown above the point-of-regard 106. Therefore, the person is required to turn his/her head downward to deliberately make the user interface element 104 coincide with the point-of-regard 106.

In some embodiments the processor 113 determines whether the gaze dwells on the recognised object for a predefined second period of time while the spatial expanse of the user interface element and the gaze coincide.

This predefined second period of time serves as a confirmation that the user deliberately desires to communicate with the object of interest 101. In the affirmative event, the event is processed by issuing an action e.g. comprising communicating a message to a remote system 115 via a communications unit 112. Communication may take place wirelessly via antennas 114 and 116. Communication may take place in various ways e.g. by means of a wireless network e.g. via a so-called Wi-Fi network or via a Bluetooth connection.

The processor 113 continuously checks whether the gaze remains fixed on the object or not (even while moving the head). The whole process will be terminated and the user interface element will be hidden when the user moves his gaze, i.e. looks away for a period of time. Thus, rapid eye movements where the user looks away unintentionally, e.g. for less than 200-500 milliseconds e.g. 100 milliseconds, may be disregarded such that the interaction via the user interface is not unintentionally disrupted.

The remote system 115 is in communication with the object of interest by a wired and/or wireless connection. The remote system 115 may also be integrated with the lamp in which case such an object as the lamp is often denoted a network enabled device. Network enabled devices may comprise lamps or other home appliances such as refrigerators, automatic doors, vending machines etc.

The system may also be configured to e.g. take a photo (record an image) by means of the scene camera 107 or to trigger and/or perform other operations such as retrieving data and or sending data e.g. for sending a message. The system is not limited to activating or communicating with remote devices.

The wearable computing device 108 is shown integrated with a spectacle frame, but may equally well be implemented integrated with a headband, a hat or helmet and/or a visor.

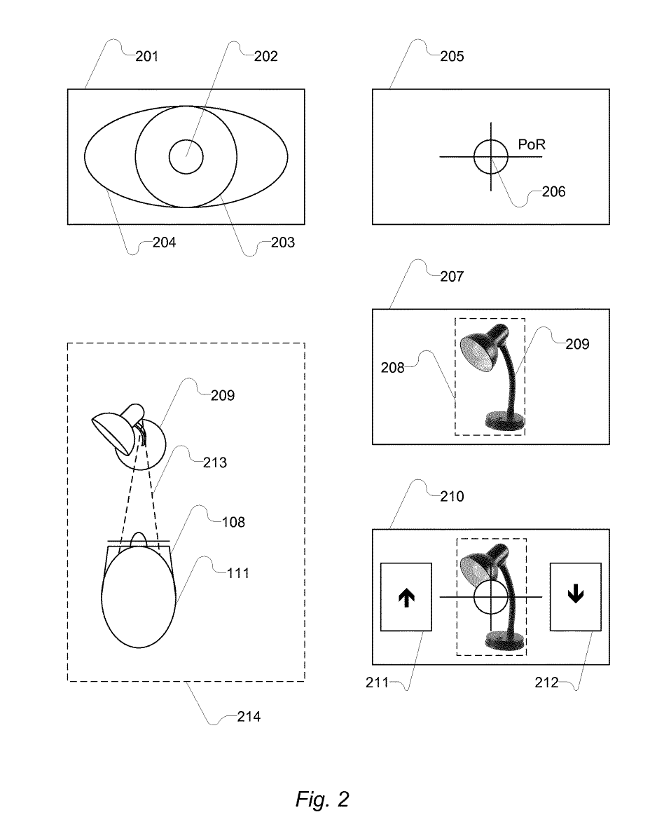

FIG. 2 shows, in a first situation, frames representing information received or displayed by the computer-implemented method. A frame 201 shows an image captured by the eye-tracker or rather a camera thereof. The image may have been cropped to single out a relevant region around the person's eye. The image shows a person's eye socket 204, his/her iris 203 and the pupil 202. Based on a calibration step, the eye-tracker is configured to compute an estimate of the person's gaze e.g. in the form of a gaze vector which may indicate a gaze direction relative to a predefined direction, e.g. the direction of the eye-tracker's camera or a vector normal to a region of the display 103 of the wearable device 108.

A frame 205 depicts the location of a point-of-regard 206 on a display. The display may not show this point-of-regard as the user may not need this information.

A frame, 207, shows an object of interest, 209, which by way of example is shown as a lamp. The lamp may be viewable to the person directly through a see-through display or via the combination of a scene camera and a non-see-through display. A box 208 is shown as a so-called bounding box and it represents the location of the object of interest 209. The location of the object of interest may be represented by a collection of coordinates or one or multiple geometrical figures. The location may be estimated by the processor 113, and the estimation may involve object location and/or object recognition techniques.

A frame 210 shows the object of interest 209, the box 208, the point-of-regard 206, and a first user interface element 211 and a second user interface element 212. The content of the display 103 as seen by the person may be the object of interest 209 (the lamp) and the user interface elements 211 and 212. The user interface elements 211 and 212 have labels or icons showing an upwardly and downwardly pointing arrow, respectively.

The situation is also shown in a top-view 214, where the lamp 209 is shown straight in front of the person's head 111 while the person is wearing the wearable computing device.

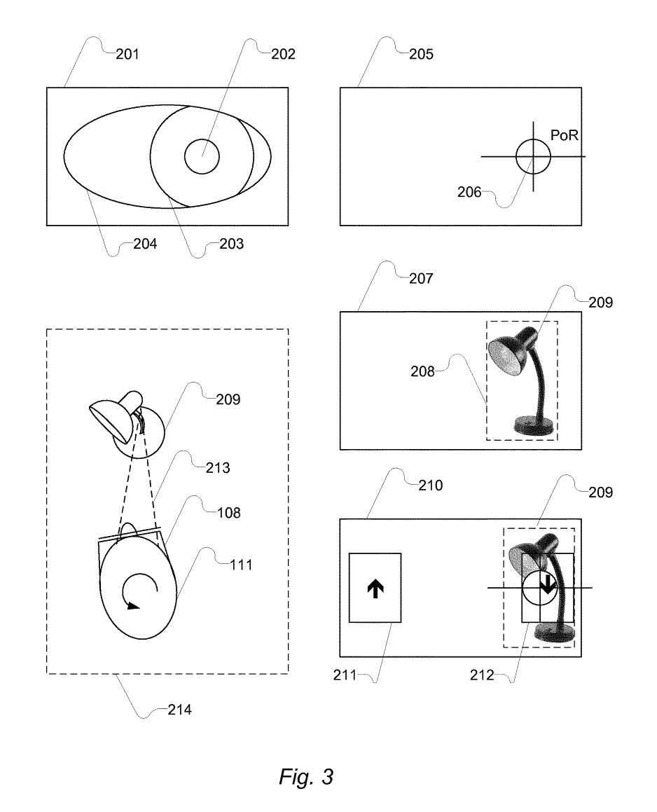

FIG. 3 shows, in a second situation, frames representing information received or displayed by the computer-implemented method. The frames can be compared with the frames of FIG. 2. As can be seen from the top-view 214, the person has turned his/her head a bit to the left while his/her gaze continues to dwell on the object of interest 209.

The eye-tracker may therefore detect that at least one of the eyes with iris 203 and pupil 202 has moved to the right in the eye socket 204. The position of the point-of-regard can be updated as shown in frame 205, where it is shown that the point-of-regard has moved to the right in the frame.

In frame 207 it is correspondingly shown that the object of interest appears to the person rightmost or to the right in the display.

As shown in frame 210, the point-of-regard 206 coincides with the object of interest 209 and the second user interface element 212. This event is detected and in correspondence with the icon shown on the user interface element (a downwardly point arrow), a message is communicated to the object of interest to dim the light.

In some embodiments, the object of interest responds to this message, e.g. by dimming light, until the method detects a second event that the person looks away and communicates a further message indicating that light dimming shall stop at a level reached when the person looks away.

Gradual increase or decrease of the light intensity may be controlled via a series of user interface elements each providing a discrete value or by a single user interface element, wherein gradual control is obtained by detecting where or how far from a border or centre the point-of-regard is located within the expanse of the user interface element.

In this example the physical object is shown as a lamp, but the object may be of another type and cause the user interface to display other controls than for controlling dimming of light. In some embodiments the system recognises an object and determines which controls are available for the recognised object and which control(s) to display to the user.

Other ways of graphically representing a user interface element or multiple user interface elements are possible as known in the art. Thus, a gaze-coincidence method is described by way of an example. By detecting and responding to an intersection or coincidence between: firstly an estimated gaze point and an object of interest, and secondly a subsequently estimated gaze point and a user interface element, it is possible to use a person's head movements in combination with his/her gaze to interact with a computer system or a computer-controlled device.

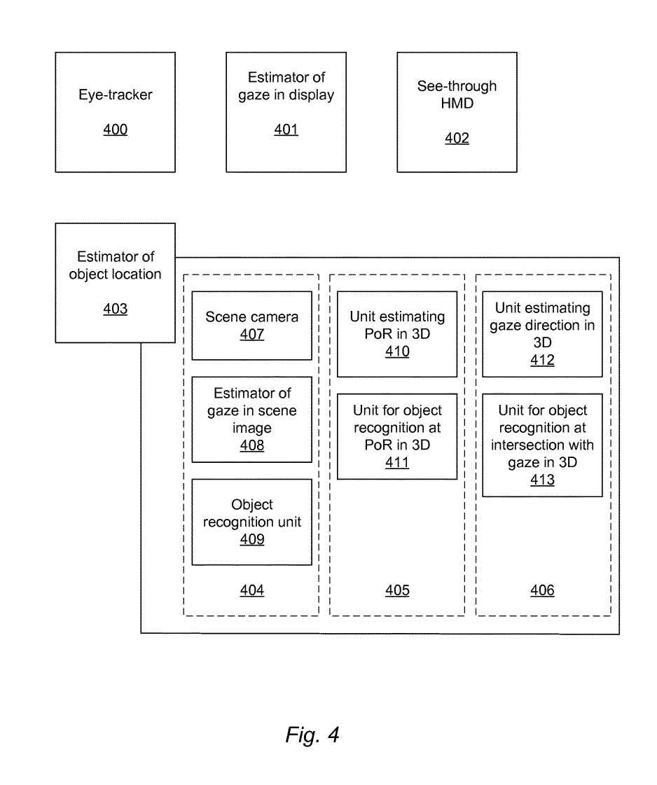

FIG. 4 shows a block diagram for a computer system configured to perform the method. Components that are involved in implementing the gaze coincidence method on a see-trough HMD are shown. Main components are an eye-tracker 400, an estimator of gaze in display 401, a see-through display 402 and an estimator of object location 403. The estimator of object location 403 may comprise different components. The components designated reference numerals 404, 405, and 406 are three alternative configurations of embodiments.

The proposed method may involve different hardware and software components when it is implemented in other embodiments.

The eye-tracker 400 typically comprises one or two infrared cameras (which may be monocular or binocular) for capturing an eye image and also infrared light sources serving to provide geometrical reference points for determining a gaze. Information obtained from the eye image by the eye tracker is used for estimating the gaze point in the two-dimensional plane of the HMD and also for determining which object the user is looking at in the scene (environment).

Since the user is not looking at the HMD while interacting with the object, the actual gaze point is on the object not in the display. However, in this application, the gaze point on the display is referred to the intersection between the visual axes and the display. Estimating the gaze point on the display plane of the HMD is performed in the component 401. The component 402 is the HMD on which the user interface and other information can be displayed. The component 403 is configured to identify and recognize the gazed object. This component can be implemented in different ways. Three different conventional configurations of components 404, 405, and 406 for implementing this component 403 are shown in FIG. 4. These three example configurations are described below:

Component 404 makes use of a scene camera 407 (similar to camera 107) that records the front view of the user (i.e. in the direction the user's face is pointing). A gaze estimation unit 408 estimates the gaze point inside the scene image. The output of the unit 408 is used in the object recognition unit 409 that processes the scene image and identifies the gazed object in the image. There are many different approaches for object recognition in the image.

Component 405 shows another configuration where a scene camera is not needed. Component 410 estimates the point of regard in a 3D coordinate system. This requires a different setup for the eye-tracker; one exemplary setup uses a binocular eye-tracker with multiple light sources along with sensors for measuring the position and orientation of the user's head in 3D space. The eye-tracking unit provides enough information to allow the 3D point of regard to be estimated relative to the head. Then, the 3D point of regard can be obtained relative to the world coordinates system by knowing the head position and orientation. Such a system also needs more information about the scene and the actual location of the objects in the environment. By knowing the 3D coordinates of the point of regard and the objects in the environment, a component 411 can identify the gazed object.

Another component 406 uses a different eye-tracking setup and estimates the user's gaze as a 3D vector relative to the head. Having the position and orientation of the user's head (measured by sensors), the gaze vector can be estimated in the 3D space 412. The unit 413 finds the intersection of the gaze vector with the objects in the environment and recognizes the object that intersects the gaze. This also requires more knowledge about the geometry of the environment and the location of the objects in the world coordinate system.

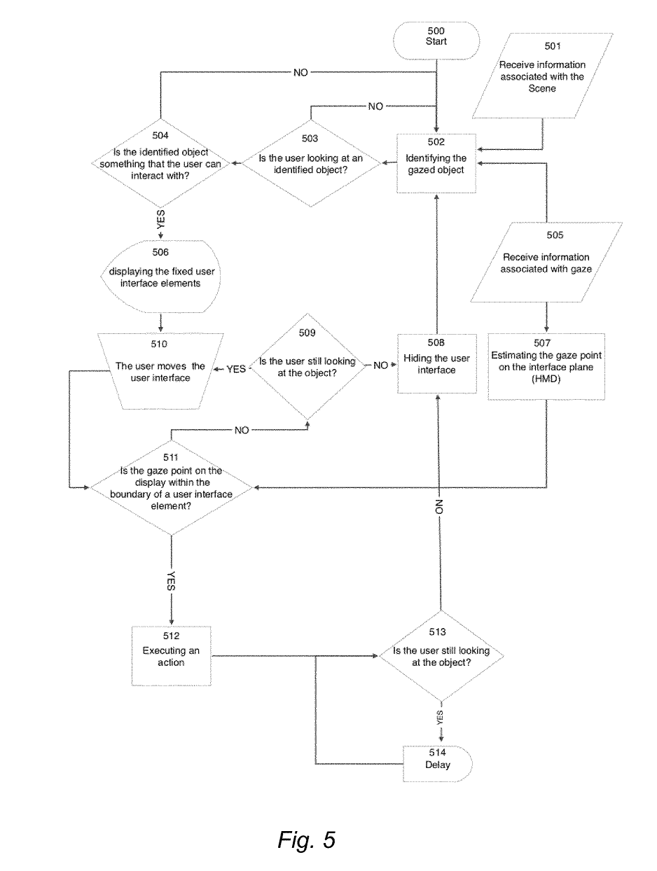

FIG. 5 shows a flowchart for the computer-implemented method of interacting with an object using a see-through HMD embodiment

The method obtains input data by means of steps 501 and 505. Step 501 receives information associated with the scene as input to the process of identifying the gazed object, i.e. the object the person is looking at. Information associated with the scene (scene-associated information) may be different for each embodiment cf. e.g. the embodiments described in connection with FIG. 4. For example, in component 404 the scene-associated information is a front view image captured by a scene camera. However, in the embodiments comprising components 405 and 406, the information comprises information about the geometry of the environment and the location of the objects.

Step 505 provides information associated with the person's gaze. This information may come from sources such as an eye-tracker, positional sensors, and/or accelerometers.

The method tries in step 502 to identify and recognize a gazed object in the environment after receiving information associated with the scene and the user's gaze. An optional step is to display some relevant information on the HMD once the gazed object has been identified (e.g. showing the name and identity of the gazed object).

Step 503 checks whether the person is looking at an identified object e.g. by using a dwell time of the person's gaze; in the positive event thereof, the method proceeds to step 504 and in the negative event thereof (NO), the method returns to step 502.

Step 504 checks whether the recognized object is of a type that the person can interact with; in the negative event thereof (NO), the method returns to step 502; and in the positive event thereof (YES), the method continues to step 506. Continuing from step 505, step 507 estimates the gaze point on the interface plane of the HMD.

In step 506, the method displays a visual representation of a user interface (UI) element on the display at a location next to the point-of-regard on the HMD plane. The location of the UI element will remain fixed relative to the HMD coordinates system even when the HMD is moved relative to the object. After displaying the user interface, the person moves the HMD by moving his/her head in step 510 with the aim of moving the desired icon (UI element) towards the object in the field of view. While moving his/hers head and hence the UI element (in step 510) the method checks in step 511 whether the gaze point in the HMD is within the spatial expanse of an UI element and, in the positive event, issues an action, which is executed in step 512.

While the UI element is shown on the display (by step 506), step 309 checks whether the person is still looking at the object. Anytime the user looks away and the gaze point is not on the object anymore, the process initiated in step 511 (by displaying the UI elements) will be terminated and the user interface will disappear i.e. will no longer be shown on the HMD. This is performed by step 509 that checks whether the user is still looking at the object and step 508 that hides the UI element in case the user looks away. After the action is executed or during its execution the UI elements will disappear and the system waits until the user's gaze has left the recognized object cf. steps 513 and 514.

The proposed technique can be used for interaction with non-see-through HMDs. In this embodiment a virtual environment will be displayed on the HMD that covers the user's field-of-view (FOV). Another layer of information can also be shown e.g. a virtual reality video such as graphical user interface (menus or buttons) or some other information. In this embodiment, the gaze coincidence technique provides a hands-free interaction method with the virtual objects by means of the user interface. Compared to the see-through HMD, the user can interact with objects in the virtual environment displayed in the HMD (101 in a virtual space). In such embodiments of a head-mounted virtual reality system, position sensors and/or accelerometers are used for measuring the head orientation and/or movements in order to move virtual objects in or out of the person's field of view as the person moves or turns his/her head to give the person a perception of a virtual world with a fixed coordinates system relative to the real world coordinates system.

Therefore, when the person looks at an object and moves his/her head, the gaze point on the display will move as well. However, when implementing the gaze coincidence method the UI elements that pop up around the gazed object do not move with the object while the head is moving and they are fixed relative to the HMD frame.

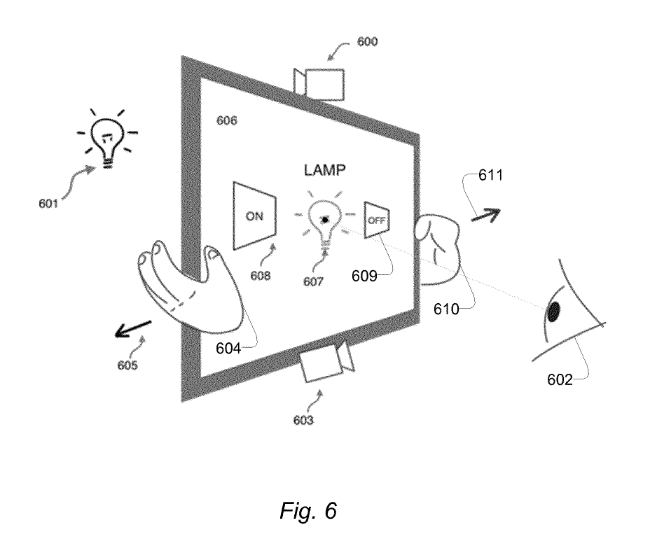

FIG. 6 shows a tablet configuration of a computer system configured to perform the method. The gaze coincidence method can be also used for interaction with an augmented reality shown on a mobile device 612 (such as a mobile phone or a tablet computer) with a display 606. An image of the environment captured by a backside camera 600 of the mobile device 612 is displayed on the display 606. When an object of interest, as exemplified by a light bulb 607 is identified by the system, control buttons 608 (‘On’) and 609 (‘Off’) will be shown around the object and their positions in the image remain fixed (do not move with object). Instead of choosing the buttons by touching the screen, the user can keep looking at the object in the image and move the device 612 such that the desired button coincides with the object 607. In this embodiment, the eye-tracker 603 can be mounted either on the display or on the user's head. Gaze points only inside the display plane need to be estimated. The user's eye is generally designated reference numeral 602.

A user's left and right hands are referred to be reference numerals 604 and 610. Arrow 605 and arrow 611 indicates that the user can move the device 612 in a left handside direction or a right handside direction, respectively, to move either control button 608 or 609 to coincide with the object 607.

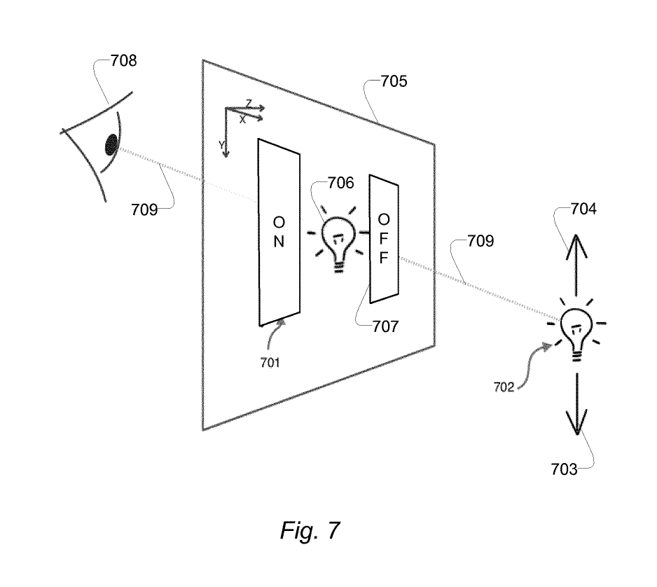

FIG. 7 shows how to arrange user interface elements when an object is moving. In general the user's eye is designated reference numeral 708 and an estimated gaze or gaze vector is designated 709.

The proposed method for interaction with object through a transparent user interface display 705 can be used for interaction with objects that are not stationary. However, these cases require different designs for the UI elements, 701 and 707. For example an object 702 has a vertical movement up or down along the shown y-axis as illustrated by arrows 703 and 704 relative to the user interface display 705 e.g. in the form of a HMD. The object 702 as it appears on or through the transparent interface display 705 is designated 706.

As will appear from FIG. 7, vertical movement (y-axis) of the object while the gaze is fixed on the object and the UI display is fixed does not lead to the method performing an action. It is because the UI elements are arranged horizontally (along the shown x-axis) and the gaze point on the display reaches the UI elements only when the user moves the display horizontally. In this type of situation the system needs to be able to detect and measure the movement of the object as well as identify it. This can be done by computer vision techniques on the scene image (in case the system makes use of a scene camera for recognizing the object) or by other means. However, this technique might not be applicable when the object moves very fast or the movement follows a complex path. This has to do with the saccadic eye movements that occur when the user is looking at an object that moves faster than 15 degrees per second.

In the embodiments where the object of interest is a real object and has a communications interface for receiving actions or messages, there might be different ways for sending the action commands to the object. This communication can be wired or wireless. The wireless communication can be established via e.g. a Wi-Fi, or a Bluetooth or an infrared communication device.

Depending on the type of the object and the action command, the system can provide different types of visual or auditory feedback for the user after executing the action. In some cases the changes in the state of the object can be seen or be heard directly after the interaction e.g. turning a lamp on or off or when adjusting the volume of music player. The system can also provide additional information for the user as the feedback when it is needed. For example, the system can make a sound, or display a message on the display, or create a sensible vibration for approving the action command or indicating the successful selection.

Object recognition—in computer vision—is the task of finding a given object in an image or video sequence. Objects can be recognized even when they are partially obstructed from view. Conventional classes of technologies for object recognition comprise appearance-based methods e.g. using edge matching, divide-and-conquer search, grayscale matching, gradient matching, histogram of receptive field responses and large model bases; feature-based methods e.g. using interpretation trees, hypothesis and test, pose consistency, pose clustering, scale-invariant feature transform; or other classes of technologies for object recognition e.g. unsupervised learning.

A protocol for communicating massages may be selected from the group of: INSTEON by SmartLabs, Inc.; DASH7, for wireless sensor networking; Enocean; HomePlug; KNX (standard), for intelligent buildings; ONE-NET; Universal powerline bus (UPB); X10; Z-Wave; and/or ZigBee. The protocol may be a home automation protocol or another type of protocol e.g. for industrial machines or for medical devices and apparatuses. A protocol may comprise a protocol negotiation mechanism.

1. A computer-implemented method of responding to a person's gaze, comprising:
computing an estimate of the person's gaze comprising computing a point-of-regard on a screen through which the person observes a scene;
identifying an object the person is looking at, if any, using the estimate of the person's gaze and information about an object's identity and location relative to the gaze;
detecting an event indicating that the person wants to interact with the object, and in response thereto displaying a predefined user interface element on the screen in a region adjacent to the point of regard; verifying, during movement of the screen, that gaze is fixed on the object; and then detecting the event that the point-of-regard coincides with the spatial expanse of a predefined displayed user interface element; and
processing the event that the point-of-regard coincides with the spatial expanse of a predefined displayed user interface element comprising performing an action.

2. (canceled)

3. A computer-implemented method according to claim 1, further comprising:
entering an interaction state as of the moment an object the person is looking at is identified;
while in the interaction state detecting whether the person's gaze is away from the object; and
in the positive event thereof, exiting the interaction state to prevent performing the action.

4. A computer-implemented method according to claim 1, further comprising:
displaying multiple user interface elements, with respective spatial expanses, on the display on a location adjacent to the point-of-regard; wherein the user interface elements are linked with a respective action;
determining which, if any, among the multiple user interface elements the point-of-regard coincides with; and
selecting an action linked with the determined user interface element.

5. A computer-implemented method according to claim 1, further comprising:
arranging the location and/or size of one or multiple user interface element(s) on the user interface plane in dependence of the distance between the location of the point-of-regard and bounds of the user interface plane.

6. A computer-implemented method according to claim 1, further comprising:
estimating a main direction or path of a moving object; and
arranging the location of one or multiple user interface element(s) on the display within at least one section thereof in order to prevent unintentional collision with the object moving in the main direction or along the path.

7. A computer-implemented method according to claim 1, further comprising:
transmitting the message to a remote station configured to communicate with the identified object and/or transmitting the message directly to a communications unit installed with the identified object.

8. A computer program product comprising program code means adapted to cause a data processing system to perform the steps of the method according to claim 1, when said program code means are executed on the data processing system.

9. A computer data signal embodied in a carrier wave and representing sequences of instructions which, when executed by a processor, cause the processor to perform the steps of the method according to claim 1.

10. A mobile device, such as a head-worn computing device, configured with a screen and to respond to a person's gaze, comprising:
an eye-tracker configured to compute an estimate of the person's gaze comprising computing a point-of-regard on a screen through which the person observes a scene;
a processor configured to identify an object the person is looking at, if any, using the estimate of the person's gaze and information about an object's identity and location relative to the gaze; and
a processor configured to: detect the event that the person wants to interact with the object, and in response thereto displaying a predefined user interface element on the screen in a region adjacent to the point of regard; verify, during movement of the screen, that gaze is and remains fixed on the object; and then detect the event that the point-of-regard coincides with the spatial expanse of the predefined user interface element on the screen, and to process the event that the point-of-regard coincides with the spatial expanse of a predefined displayed user interface element comprising performing an action.

11. (canceled)

12. A mobile device according to claim 10 configured to
enter an interaction state as of the moment an object the person is looking at is identified; and
while in the interaction state, detect whether the person's gaze is away from the object; and in the positive event thereof, exit the interaction state to prevent performing the action.

13. A mobile device according to claim 10 configured to:
display multiple user interface elements, with respective spatial expanses, on the screen on a location adjacent to the point-of-regard; wherein the user interface elements are linked with a respective action;
determine which, if any, among the multiple user interface elements the point-of-regard coincides with; and
select an action linked with the determined user interface element.

14. A mobile device according to claim 10, configured to:
arrange the location and/or size of one or multiple user interface element(s) on the screen in dependence of the distance between the location of the point-of-regard and bounds of the user interface plane.

15. A mobile device according to claim 10, configured to:
estimate a main direction or path of a moving object; and
arrange the location of one or multiple user interface element(s) on the display within at least one section thereof in order to prevent unintentional collision with the object moving in the main direction or along the path.

16. A mobile device according to claim 10, configured to:
transmit the message to a remote station configured to communicate with the identified object and/or transmitting the message directly to a communications unit installed with the identified object.
